(19) United States
(12) Patent Application Publication
(10) Pub. No.: US 2026/0132834 A1
(43) Pub. Date: May 14, 2026

(54) APPARATUS FOR CONNECTING A VALVE DEVICE TO A VIBRATION DAMPER; VIBRATION DAMPER

(71) Applicants: thyssenkrupp Bilstein GmbH, Ennepetal (DE); thyssenkrupp AG, Essen (DE)

(72) Inventor: Jens ROBRECHT, Nettersheim (DE)

(73) Assignees: thyssenkrupp Bilstein GmbH, Ennepetal (DE); thyssenkrupp AG, Essen (DE)

(21) Appl. No.: 19/384,845

(22) Filed: Nov. 10, 2025

(30) Foreign Application Priority Data
Nov. 11, 2024 (DE) 10 2024 132 758.8

(51) Int. Cl. F16F 9/32; F16F 9/36; F16L 25/04

(52) U.S. Cl. CPC F16F 9/3271; F16F 9/369; F16L 25/04

(57) ABSTRACT

An apparatus for connecting a valve device, in particular a bypass device, to a connecting portion of a vibration damper comprises at least one elongate holding element with a first and a second axial end and a contact region which extends between the axial ends, wherein the holding element is arranged in the installed state such that the contact region at least partially encloses the outer circumference of the connecting portion and the axial ends of the holding element pass through receiving openings in a valve housing of the valve device, wherein respective securing elements of the apparatus are arranged at the axial ends of the holding element, said securing elements fastening the valve housing to the connecting portion by bracing.

### CROSS REFERENCE TO RELATED APPLICATION

This application is a U.S. Non-Provisional that claims priority to German Patent Application No. DE 10 2024 132 758.8, filed Nov. 11, 2024, the entire content of which is incorporated herein by reference.

### FIELD

The present disclosure relates to an apparatus for connecting a valve device, in particular a bypass device, to a connecting portion of a vibration damper. The invention also relates to a vibration damper having at least one such apparatus and to a method for connecting a valve device to a connecting portion of a vibration damper by means of such an apparatus.

### BACKGROUND

Vibration dampers are usually used for motor vehicles and in industry in order to ensure safe and comfortable driving behaviour of a vehicle under different driving conditions caused by irregularities, for example uneven surfaces, potholes or other anomalies in the road surface. Furthermore, vibration dampers also serve to stabilize vehicles when driving under relatively extreme conditions, for example when driving off road.

Valve devices for setting the damping force of the vibration damper, for example bypass devices, are, in the installed state, often arranged laterally on a vibration damper or connected to the outer tube of the vibration damper. In order to ensure the function of the vibration damper with such a valve device, a fluid-tight connection between the valve device and the vibration damper should be established. To this end, the valve housing of such a valve device is usually connected to the outer tube of the vibration damper by welding. This can result in damage, such as warping or structural changes, on the valve housing and/or on the outer tube of the vibration damper, however.

Thus a need exists to specify an apparatus for connecting a valve device to a connecting portion of a vibration damper, by means of which a fluid-tight connection between the valve device and the vibration damper is achievable without causing damage on the valve device or the vibration damper. The invention also addresses the problem of specifying a vibration damper having such an apparatus, and a method for connecting a valve device to a connecting portion of a vibration damper by means of such an apparatus.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a perspective view of a vibration damper having an apparatus for connecting a valve device to a connecting portion of the vibration damper according to one exemplary embodiment according to the invention.

FIG. 2 shows a longitudinal section through the vibration damper according to FIG. 1.

FIG. 3 shows an enlarged detail of the connecting portion of the vibration damper according to FIG. 1, at which a valve device is arranged.

FIG. 4 shows a side view of the connecting portion of the vibration damper according to FIG. 3.

FIG. 5 shows an enlarged detail of the connecting portion of the vibration damper according to FIG. 1, at which a valve device is arranged.

FIG. 6 shows an enlarged detail of the connecting portion of the vibration damper according to FIG. 1 with the holding element of the apparatus.

FIG. 7 shows a perspective view of the holding element of the apparatus according to FIG. 1.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

Specifically, the problem is solved by an apparatus for connecting a valve device to a connecting portion of a vibration damper, said apparatus having at least one elongate holding element with a first and a second axial end and a contact region which extends between the axial ends. The holding element is arranged in the installed state such that the contact region of the holding element at least partially encloses the outer circumference of the connecting portion and the axial ends of the holding element respectively pass through a receiving opening in a valve housing of the valve device. Respective securing elements of the apparatus are arranged at the axial ends of the holding element, said securing elements fastening the valve housing to the connecting portion by bracing.

### The Invention Has Various Advantages.

Thus, the apparatus according to the invention allows a valve device to be connected to a vibration damper in a fluid-tight manner. As a result, the escape of damper fluid at the connecting point between the valve device and the connecting portion of the vibration damper is prevented. This is achieved in that the apparatus exerts, in the installed state, a particular force, in particular a pressure force, on the connecting point or sealing point. To this end, the apparatus comprises at least one holding element and at least two securing elements. In the installed state, the holding element and the securing elements are arranged such that the valve device is pressed against the connecting portion of the vibration damper. The valve device is thus fastened to the connecting portion by bracing. A fluid-tight connection is ensured in this way.

The holding element of the apparatus is elongate, in particular substantially cylindrical, and has a first and a second axial end. A contact region, extending between the axial ends, of the holding element is designed such that, in the installed state, it at least partially encloses the outer circumference of the connecting portion. This should preferably be understood as meaning that the contact region of the holding element is matched to the outer circumference of the connecting portion or can follow the geometry of the connecting portion. In particular, the contact region, in the installed state, encloses that circumferential region of the connecting portion that faces away from the valve device.

The contact region of the holding element is preferably curved such that, in the installed state, it encloses (only) that subregion of the outer circumference of the connecting portion that faces away from the valve device, with the result that the preferably substantially straight axial ends of the holding element are oriented in the direction of the valve device. As a result, the axial ends of the holding element can pass through corresponding receiving openings in the valve housing of the valve device.

A securing element is able to be arranged at respective axial ends of the holding element. The axial ends pass through the receiving opening preferably such that there is enough space for the securing elements. As a result, the securing elements can be arranged such that, in the installed state, they push or press the valve device against the connecting portion.

The securing elements are connected preferably releasably to the axial ends of the holding element. As a result, the connection between the valve device and the connecting portion of the vibration damper is easy to release. In this way, easy assembly and disassembly of the apparatus is also achieved.

It is also advantageous that damage both on the vibration damper and on the valve device by the connection of the two components is able to be avoided by the apparatus according to the invention. Since the apparatus connects the valve device and the vibration damper by bracing, substance-to-substance types of connection, for example welding, which would result in damage on the vibration damper or on the valve housing, can be dispensed with.

The connecting portion of the vibration damper is preferably in the form of a separate part which is able to be connected to the outer tube of the vibration damper. For example, the connecting portion may be substantially hollow-cylindrical. Preferably, the connecting portion is a turned part. Alternatively, it is possible for the connecting portion to be formed in one piece with the outer tube of the vibration damper.

Furthermore, the valve housing may be in the form of a separate component and may have been produced, for example, by turning. Producing the valve housing and the connecting portion of the vibration damper as separate components results in a cost benefit, particularly compared with known vibration dampers, in which the valve housing and the outer tube of the vibration damper are formed integrally.

The valve device is preferably in the form of an external valve device which is able to be arranged on the outer side of the vibration damper. The valve device may comprise at least one, in particular adjustable, damper valve. Preferably, the valve device comprises a plurality of, in particular four, damper valves, which are arranged in the valve housing.

Particularly advantageously, the apparatus according to the invention allows a valve device, which is in the form of a bypass device, to be connected to the vibration damper. By means of the bypass device, a change in the bypass current in a vibration damper can be achieved. Within a vibration damper, the bypass device can be provided to allow the damper fluid to flow between working chambers of the vibration damper which are separated from one another by a working piston, bypassing a piston valve of the working piston. In other words, a bypass fluidic connection can be created, by way of which a partial flow of the damping medium is conducted through the damper valve, past the piston valve. In this case, the partial flow of the damper fluid through the damper valve can be adjusted in order to adapt the operating characteristics of the vibration damper in a targeted manner, for example before the vehicle is put into racing use.

At least the contact region of the holding element may have a curvature which is matched to the outer circumference of the connecting portion of the vibration damper. This should preferably be understood as meaning that at least the contact region of the holding element is formed in a curved manner in order to enclose the outer circumference of the connecting portion. In other words, the contact region of the holding element is preferably curved such that it lies against the connecting portion. The radius of curvature of the contact region advantageously corresponds substantially to the outside radius of the preferably hollow-cylindrical connecting portion. As a result, a secure connection between the connecting portion of the vibration damper and the valve device is achieved.

Preferably, the holding element is substantially U-shaped. In other words, the holding element is substantially in the shape of a U. This geometry has been found to be particularly advantageous since, as a result, the contact region of the holding element is curved such that it can enclose the outer circumference of the connecting portion, and the axial ends of the holding element are straight such that they can pass through the receiving openings in the valve housing.

The contact region of the holding element is preferably shaped so as to correspond to a supporting region of the connecting portion, which extends in the circumferential direction of the connecting portion. At least that region of the connecting portion that faces away from the valve device in use has a supporting region for the holding element or the contact region of the holding element. The supporting region is preferably shaped so as to correspond to the contact region such that a movement of the holding element in a longitudinal direction of the vibration damper is avoided. In other words, the holding element is arranged by the supporting region so as to be non-displaceable in the longitudinal direction of the vibration damper. As a result, the reliability of the connection between the valve device and the vibration damper is increased.

The supporting region may form a depression in the connecting portion of the vibration damper, said depression extending in the circumferential direction of the connecting portion. The depression or recess is preferably shaped so as to correspond to the contact region of the holding element. If the contact region is substantially cylindrical, the connecting portion preferably has a concave or inwardly curved depression. In use, the contact region is preferably arranged in the depression such that slipping of the holding element in the longitudinal direction of the vibration damper is avoidable.

Alternatively, the supporting region may be in the form of a shoulder or protrusion, against which the contact region of the holding element lies in use. The shoulder or protrusion may extend over a subregion of the outer circumference of the connecting portion.

The first and second axial ends of the holding element advantageously each have a securing region for receiving the securing elements. The securing region may be in the form of an external thread. In this case, the securing elements preferably have an internal thread such that the securing elements can be screwed together with the securing regions. The securing elements are in this case in the form of nuts. As a result of this screw connection, it is easily possible to brace the valve device with respect to the connecting portion of the vibration damper.

The connecting portion of the vibration damper and the valve housing of the valve device preferably have a sealing surface for a sealable transition between the valve device and the vibration damper. The sealing surfaces are preferably shaped so as to correspond to one another such that the escape of damper fluid is avoided. The sealing surfaces may receive sealing elements, for example O-rings, in order to create a fluid-tight transition between the valve device and the vibration damper.

The connecting portion, in particular the sealing surface of the connecting portion, may have at least one port opening for the fluidic connection of the valve device to the vibration damper. The port openings allow a fluidic connection of the valve device to a working chamber and/or a balance chamber of the vibration damper. Around the port openings, a groove for receiving a sealing element, for example an O-ring, may be provided. In this way, a fluid-tight connection of the valve device to the vibration damper is achieved.

Preferably, the sealing surface of the connecting portion and/or the sealing surface of the valve housing has/have at least one centering or centring element for orienting the valve housing with respect to the connecting portion. The centring element may be, for example, an alignment pin. The sealing surface of the connecting portion and/or of the valve housing may have at least one bore for receiving the alignment pin. By means of the centring element, the correct position of the valve device on the connecting portion and thus a fluid-tight connection are achieved.

In some embodiments, the invention relates to a vibration damper having at least one apparatus according to the invention for connecting a valve device to a connecting portion of the vibration damper. To this end, reference is made to the advantages explained in conjunction with the apparatus. Furthermore, the vibration damper may alternatively or additionally have individual features mentioned above in relation to the apparatus or a combination of several of these features.

In some embodiments, the invention relates to a method for connecting a valve device to a connecting portion of a vibration damper by means of an apparatus, in particular according to the invention. First of all, a vibration damper having a connecting portion for a valve device is provided. Then, the valve device can be arranged at the connecting portion of the vibration damper. In particular, the valve device is arranged at the connecting portion such that a fluidic connection is able to be established between the valve device and the vibration damper. In order to fix the position of the valve device relative to the vibration damper, the apparatus comprising an elongate holding element is used, wherein the holding element has a first and a second axial end and a contact region which extends between the axial ends. The holding element is arranged such that the contact region at least partially encloses the outer circumference of the connecting portion and the first and second axial ends of the holding element each pass through a receiving opening in a valve housing of the valve device. Finally, respective securing elements of the apparatus are arranged at the axial ends of the holding element such that the valve device is braced against the connecting portion in order to be fastened. With regard to the method, reference is made to the advantages mentioned in conjunction with the apparatus. Furthermore, the method may alternatively or additionally have individual features mentioned above in relation to the apparatus or a combination of several of these features.

The invention is explained in more detail below with further details with reference to the appended drawings. The illustrated embodiments illustrate examples of how the apparatus according to the invention and the vibration damper according to the invention can be configured.

In the following text, the same reference numerals are used for identical parts or parts having the same effect.

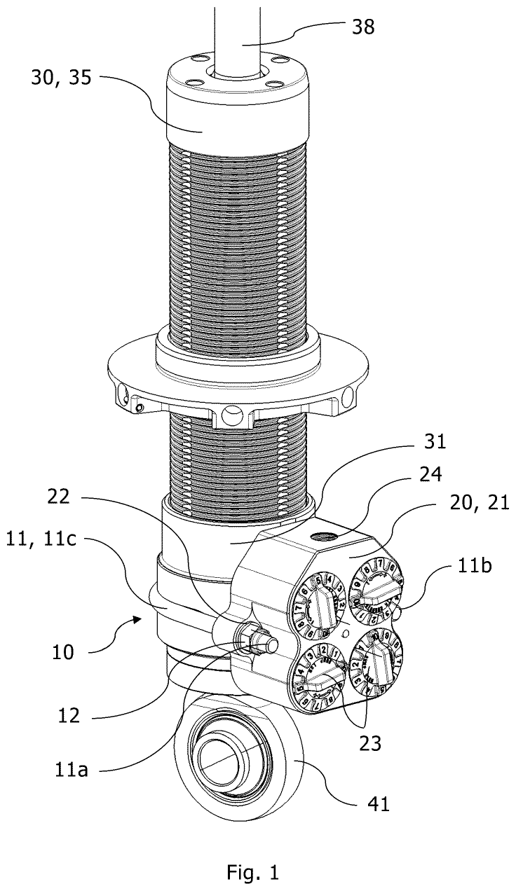

FIG. 1 shows an exemplary embodiment according to the invention of an apparatus 10. In this case, the apparatus 10 is used to connect a valve device 20 to a vibration damper 30. Other uses are possible. By means of the apparatus 10, the valve device 20 is connected to the vibration damper 30 in a fluid-tight manner.

The valve device 20 shown in FIG. 1 is arranged laterally on the vibration damper 30. The valve device 20 serves to adjust the damping force of the vibration damper 30. The valve device 20 is fluidically connected to a working chamber 39, 40 and/or to a balance chamber of the vibration damper 30 in order to adjust the damping force.

FIGS. 1, 3 and 5 show that the valve device 20 comprises four damper valve 23. In each case two damper valves 23 are provided for the rebound or pressure stage of the vibration damper 30.

The valve device 20 has a valve housing 21, which is connected to the vibration damper 30 (cf. FIG. 1). The valve housing 21 encloses the damper valves 23.

It is apparent from FIGS. 1 to 5 that the vibration damper 30 has a connecting portion 31 for the valve device 20. The connecting portion 31 is a separate component and is firmly connected to an outer tube 35 of the vibration damper 30. The connecting portion 31 is a turned part and is substantially in the form of a hollow cylinder.

The apparatus 10 shown has an elongate holding element 11 having a first and a second axial end 11a, 11b. The holding element 11 is substantially cylindrical. Other designs of the holding element 11 are possible.

Between the axial ends 11a, 11b of the holding element 11 there extends a contact region 11c, which, in the installed state, is arranged at the connecting portion 31 of the vibration damper 30, or is in contact with the connecting portion 31. FIG. 6 illustrates that the contact region 11c partially encloses the outer circumference of the connecting portion 31 of the vibration damper 30. It is apparent that the contact region 11c encloses that circumferential region of the connecting portion 31 that faces away from the valve device 20.

The first and second axial ends 11a, 11b of the holding element 11 are in contact with the valve device 20, or with a valve housing 21 of the valve device 20. The valve housing 21 has two receiving openings 22 for the axial ends 11a, 11b of the holding element 11.

The receiving openings 22 are formed in the valve housing 21. The inside diameter of the receiving openings 22 corresponds substantially to the outside diameter of the axial ends 11a, 11b.

It is clearly apparent from FIGS. 1, 3 and 5 that the holding element 11 is arranged such that the contact region 11c encloses the outer circumference of the connecting portion 31 and the axial ends 11a, 11b of the holding element 11 pass through the receiving openings 22 in the valve housing 21.

It is also apparent that respective securing elements 12 are arranged at the axial ends 11a, 11b of the holding element 11. The securing elements 12 are designed to fasten the valve device 20 to the connecting portion 31 by bracing. The securing elements 12 press the valve housing 21 against the connecting portion 31 and in this way ensure a fluid-tight connection between the valve device 20 and the vibration damper 30.

It is clear from FIG. 6 that the contact region 11c of the holding element 11 has a curvature which is matched to the outer circumference of the connecting portion 31. Specifically, the contact region 11c is matched to the outer circumference of the connecting portion 31 such that the contact region 11c lies directly against the connecting portion 31. The radius of curvature of the contact region 11c corresponds substantially to the outside radius of the hollow-cylindrical connecting portion 31.

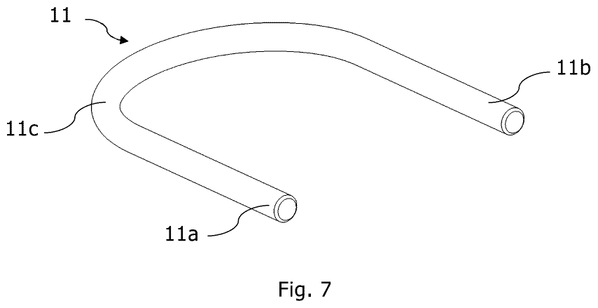

FIG. 7 illustrates that the holding element 11, or the contact region 11c of the holding element 11 is substantially U-shaped. As a result of the U-shape of the holding element 11, the contact region 11c has a curvature such that it can enclose the outer circumference of the connecting portion 31, and the axial ends 11a, 11b of the holding element 11 are substantially straight such that they can pass through the receiving openings 22 in the valve housing 21.

The contact region 11c of the holding element 11 is shaped so as to correspond to a supporting region 31a of the connecting portion 31, which extends in the circumferential direction of the connecting portion 31. It is apparent that that circumferential region of the connecting portion 31 that faces away from the valve device 20 in use has the supporting region 31a for the contact region 11c. As a result of the corresponding shape of the contact region 11c with respect to the supporting region 31a, a movement of the holding element 11 in a longitudinal direction of the vibration damper 30 is avoided. The contact region 11c of the holding element 11 fits in the supporting region 31a in a form-fitting manner. As a result, the holding element 11 is non-displaceable in the longitudinal direction of the vibration damper 30.

The supporting region 31a forms a depression or recess in the connecting portion 31 of the vibration damper 30. The depression extends in the circumferential direction of the connecting portion 31. The depression or recess is shaped so as to correspond to the contact region 11c of the holding element 11 in order to prevent the holding element 11 from moving in a longitudinal direction of the vibration damper 30. Specifically, the depression is concave or inwardly curved such that the cylindrical contact region 11c is able to be arranged in the depression.

The first and second axial ends 11a, 11b of the holding element 11 each have a securing region 13 for receiving the securing elements 12. Specifically, the securing region 13 is in the form of an external thread, which is suitable for receiving a securing element 12 with an internal thread.

FIGS. 1, 3, 4 and 5 show that the securing element 12 is in the form of a securing nut. As a result of the securing nut being screwed onto the external thread of the axial ends 11a, 11b, the valve housing 21 is pressed against the connecting portion. Other designs of the securing element 12 are possible.

The connecting portion 31 of the vibration damper 30 and the valve housing 21 of the valve device 20 have a sealing surface 25, 32 for a sealable transition between the valve device 20 and the vibration damper 30 (cf. FIG. 4). The sealing surfaces 25, 32 are flat or planar surfaces and lie against one another such that the escape of a damper fluid is avoided.

The connecting portion 31 of the vibration damper 30 and the valve housing 21 of the valve device 20 are turned parts or produced by turning. The sealing surfaces 25, 32 are produced by machining the surface of the turned parts.

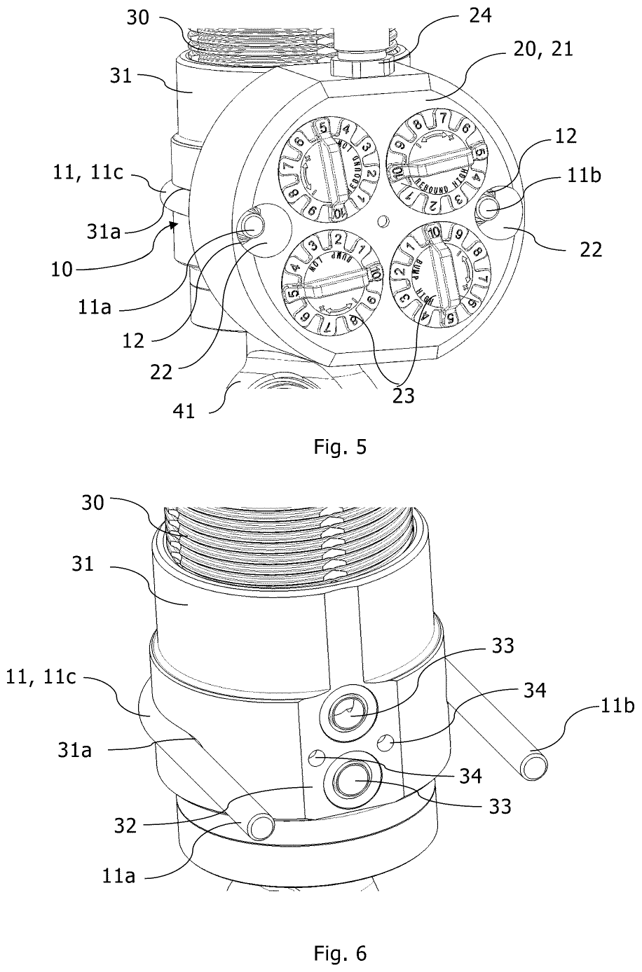

In FIG. 5 it is apparent that the valve housing 21 is substantially round and has at least two machined surfaces. Besides the sealing surface 25, the valve housing 21 has a further machined surface with an attachment region 24 for a balancing module.

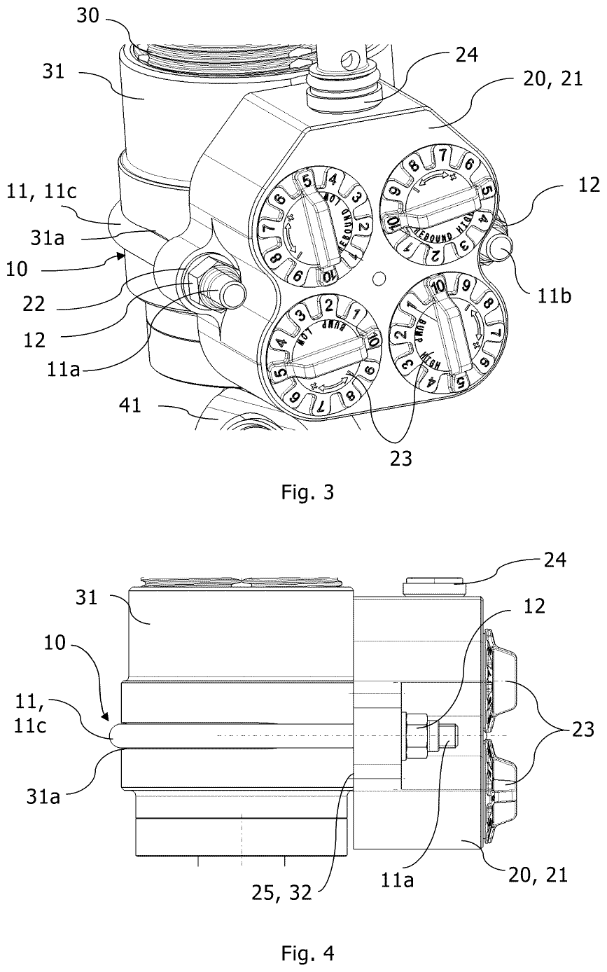

The design or shape of the valve housing 21 is variable. It is apparent from FIG. 3 that the valve housing 21 is matched to the damper valves 23. In other words, the geometry of the valve housing 21 is matched to the design of the damper valves 23.

The connecting portion 31 or the sealing surface 32 of the connecting portion 31 has two port openings 33 for the fluidic connection of the valve device 20 to the vibration damper 30 (cf. FIG. 6). The valve device 20 is arranged at the port openings 33 such that a fluidic connection between the valve device 20 and the working chambers 39, 40 or a balance chamber of the vibration damper 30 is able to be established.

As can be seen in FIG. 6, the sealing surface 32 of the connecting portion 31 has two bores 34 for receiving two centering or centring elements (not illustrated). The centring elements serve to orient the valve housing 21 with respect to the connecting portion 31. The centring elements may be, for example, pins. By means of the centring elements, the correct position of the valve device 20 at the connecting portion 31 and thus a fluid-tight connection are achieved.

FIG. 1 shows, by way of example, a vibration damper 30 on which the apparatus 10 is used. In this case, the vibration damper 30 is used for a motor-driven vehicle. Specifically, the vibration damper 30 is used for motorsport vehicles, in particular for race cars or sports cars. Other uses are possible.

The vibration damper 30 according to FIG. 1 is a twin-tube vibration damper. The vibration damper 30 has an outer tube 35 and an inner tube 36. The inner tube 36 is arranged coaxially with the outer tube 35 and forms an annular gap with the outer tube 35.

The inner tube 36 is filled with a damper fluid. The damper fluid may be a liquid or a gas. Preferably, the damper fluid used is hydraulic oil.

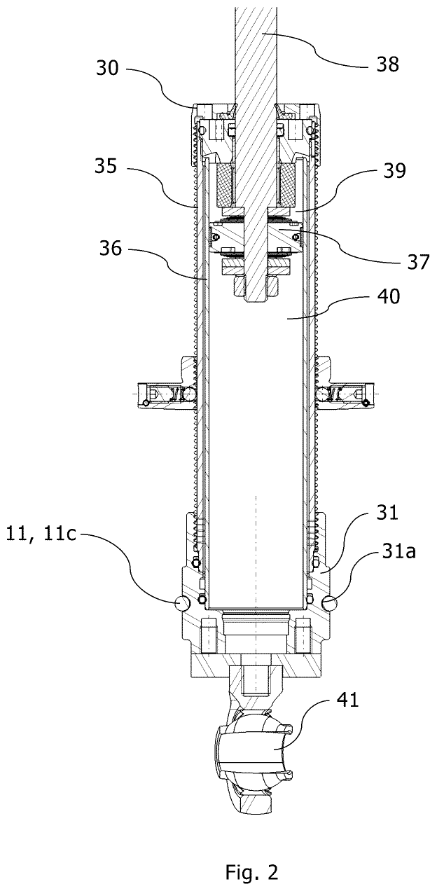

The vibration damper 30 is shown in longitudinal section in FIG. 2. It is apparent that the vibration damper 30 has a working piston 37 arranged on a piston rod 38. The piston rod 38 is arranged fixedly on the working piston 37. The working piston 37 is guided in the inner tube 36 or is axially movable in the inner tube 36. The working piston 37 subdivides the interior of the inner tube 36 into a first and a second working chamber 39, 40.

The first working chamber 40 is provided away from the piston rod and the second working chamber 39 is provided on the piston-rod side. The first working chamber 40 is formed between the working piston 37 and a longitudinal end, away from the piston rod, of the vibration damper 30. The second working chamber 39 is formed between the working piston 37 and a longitudinal end, on the piston-rod side, of the vibration damper 30.

The valve device 20 is intended to allow the damper fluid to flow between working chambers 39, 40 of the vibration damper 30, which are separated from one another by the working piston 37, bypassing a piston valve of the working piston 37. To this end, the valve device 20 is in the form of a bypass device. The valve device 20 creates a bypass fluidic connection by means of which a partial flow of the damping medium is guided past the piston valve.

The connecting portion 31 forms a longitudinal end, away from the piston rod, of the vibration damper 30. As a result, the connecting portion 31 is arranged at the longitudinal end, away from the piston rod, of the outer tube 35. The valve device 20 or bypass device is connected by the apparatus 10 to the longitudinal end, away from the piston rod, of the vibration damper 30.

FIGS. 1 and 2 show that the vibration damper 30 has a welding fork 41, which is arranged at the longitudinal end, away from the piston rod, of the outer tube 35. The welding fork 41 serves to attach the vibration damper 30 to a vehicle. Other attachment elements, for example a fork or a clamp, are possible.

The method for connecting the valve device 20 to the connecting portion 31 of the vibration damper 30 by the apparatus 10 is explained in more detail with reference to FIG. 1. First of all, the vibration damper 30, which has the connecting portion 31 for the valve device 20, is provided. Then, the valve device 20 is arranged at the connecting portion 31 such that a fluidic connection is able to be established. It is apparent that the valve device 20 is in the form of a bypass device, which is arranged laterally on the vibration damper 30 and is fluidically connected to a working chamber 39, 40 and/or a balance chamber of the vibration damper 30. In order to achieve a fluid-tight connection, the holding element 11 of the apparatus 10 is arranged such that the contact region 11c of the holding element 11 at least partially encloses the outer circumference of the connecting portion 31.

It is apparent that the contact region 11c is curved such that the contact region 11c encloses that subregion of the outer circumference of the connecting portion 31 that faces away from the valve device 20. As a result of this arrangement of the contact region 11c, the axial ends 11a, 11b of the holding element 11 extend in the direction of the valve device 20. In this case, the axial ends 11a, 11b are oriented such that they pass through the receiving openings 22 formed in the valve housing 21 of the valve device 20. Finally, respective securing elements 12 are arranged at the axial ends 11a, 11b of the holding element 11 such that the valve housing 21 is braced against the vibration damper 30. Specifically, a securing nut is screwed onto an external thread on the axial ends 11a, 11b of the holding element 11 in order to press the valve housing 21 against the connecting portion 31 of the vibration damper 30.

### LIST OF REFERENCE SIGNS

10 Apparatus
11 Holding element
11a First axial end
11b Second axial end
11c Contact region
12 Securing element
13 Securing region
20 Valve device
21 Valve housing
22 Receiving opening
23 Damper valve
24 Attachment region
25 Sealing surface of the valve housing
30 Vibration damper
31 Connecting portion
31a Supporting region
32 Sealing surface of the connecting portion
33 Port opening
34 Bore for receiving a centring element
35 Outer tube
36 Inner tube
37 Piston
38 Piston rod
39 Working chamber on the piston-rod side
40 Working chamber away from the piston rod
41 Welding fork

1. An apparatus for connecting a valve device to a connecting portion of a vibration damper, comprising:
at least one elongate holding element with a first and a second axial end and a contact region which extends between the axial ends;
wherein the holding element is arranged in the installed state such that the contact region at least partially encloses the outer circumference of the connecting portion and the axial ends of the holding element pass through receiving openings in a valve housing of the valve device;
wherein respective securing elements of the apparatus are arranged at the axial ends of the holding element, said securing elements fastening the valve housing to the connecting portion by bracing.

2. The apparatus according to claim 1, wherein the valve device is a bypass device.

3. The apparatus according to claim 1, wherein at least the contact region of the holding element has a curvature which is matched to the outer circumference of the connecting portion of the vibration damper.

4. The apparatus according to claim 1, wherein the holding element is substantially U-shaped.

5. The apparatus according to claim 1, wherein the contact region of the holding element is shaped so as to correspond to a supporting region of the connecting portion, which extends in the circumferential direction of the connecting portion.

6. The apparatus according to claim 1, wherein the supporting region forms a depression in the connecting portion of the vibration damper.

7. The apparatus according to claim 1, wherein the first and second axial ends of the holding element each have a securing region for receiving the securing elements.

8. The apparatus according to claim 7, wherein the securing regions include external threads.

9. The apparatus according to claim 1, wherein the connecting portion of the vibration damper and the valve housing of the valve device have a sealing surface for a sealable transition between the valve device and the vibration damper.

10. The apparatus according to claim 1, wherein the connecting portion has at least one port opening for the fluidic connection of the valve device to the vibration damper.

11. The apparatus according to claim 10, wherein the sealing surface of the connecting portion has the at least one port opening for the fluidic connection of the valve device to the vibration damper.

12. The apparatus according to claim 1, wherein the sealing surface of the connecting portion and/or the sealing surface of the valve housing has/have at least one centering element for orienting the valve housing with respect to the connecting portion.

13. A vibration damper having at least one apparatus for connecting a valve device to a connecting portion of the vibration damper according to claim 1.

14. A method for connecting a valve device to a connecting portion of a vibration damper using an apparatus, comprising:
providing a vibration damper having a connecting portion for a valve device;
arranging the valve device at the connecting portion of the vibration damper;
arranging a holding element of the apparatus such that a contact region of the holding element at least partially encloses the outer circumference of the connecting portion and a first and a second axial end of the holding element each pass through a receiving opening in a valve housing of the valve device; and
arranging respective securing elements of the apparatus at the axial ends of the holding element such that the valve housing is braced against the connecting portion in order to be fastened.
